(19) United States
(12) Patent Application Publication
(10) Pub. No.: US 2025/0038292 A1
(43) Pub. Date: Jan. 30, 2025

(54) BATTERY MODULE

(71) Applicant: TOYOTA JIDOSHA KABUSHIKI KAISHA, Toyota-shi (JP)

(72) Inventors: Kazuhito KATO, Toyota-shi (JP); Masato ONO, Nagoya-shi (JP); Yusuke KINTSU, Miyoshi-shi (JP); Atsushi YAMANAKA, Nagoya-shi (JP); Takaaki GOTO, Seto-shi (JP); Shintaro UTSUMI, Susono-shi (JP); Hiroki AWANO, Susono-shi (JP)

(73) Assignee: TOYOTA JIDOSHA KABUSHIKI KAISHA, Toyota-shi (JP)

(21) Appl. No.: 18/734,090

(22) Filed: Jun. 5, 2024

(30) Foreign Application Priority Data
Jul. 27, 2023 (JP) 2023-122779

(51) Int. Cl. H01M 10/613; B60L 50/64; H01M 10/625; H01M 10/647; H01M 10/653; H01M 10/6551; H01M 10/6554; H01M 50/105; H01M 50/119; H01M 50/121; H01M 50/124; H01M 50/211; H01M 50/249

(52) U.S. Cl. CPC H01M 10/613; H01M 10/625; H01M 10/647; H01M 10/653; H01M 10/6551; H01M 10/6554; H01M 50/105; H01M 50/119; H01M 50/121; H01M 50/124; H01M 50/211; H01M 50/249; B60L 50/64; H01M 2220/20

(57) ABSTRACT

A battery module includes a battery cell and a heat dissipation member that is in contact with a battery cell case. The battery cell includes an electrode body including plural layered structures layered one on another, each including a positive electrode, a negative electrode, and a separator disposed between the positive electrode and the negative electrode, and the battery cell case that hermetically encloses the electrode body inside the battery cell case. The battery cell case includes at least a metal layer and a fusion resin layer disposed at the inner face side of the metal layer and has an exposed portion, at which the metal layer is exposed, at at least part of the outer face of the battery cell case. The heat dissipation member is in contact with the exposed portion.

### CROSS-REFERENCE TO RELATED APPLICATION

This application is based on and claims priority under 35 USC 119 from Japanese Patent Application No. 2023-122779, filed on Jul. 27, 2023, the disclosure of which is incorporated by reference herein.

### BACKGROUND

Technical Field The present disclosure relates to a battery module.

### Related Art

Battery cells including an electrode body, in which plural sets each having a positive electrode, a negative electrode, and a separator are layered, and a battery cell case that encloses the electrode body inside have conventionally been used. Further, the electrode body generates heat during charging and discharging and when a short-circuit occurs, so means for dissipating heat from the electrode body to the outside have conventionally been considered.

For example, Japanese National Publication (JP-A) No. 2012-511802 discloses a battery module constructed in a structure in which plural plate-shaped battery cells are sequentially stacked in a module case, wherein each of the plate-shaped battery cells includes an electrode assembly of a cathode/separator/anode structure mounted in a battery case formed of a laminate sheet including a resin layer and a metal layer, plural heat dissipation members are disposed at two or more interfaces between the battery cells, and a heat exchange member integrally interconnecting the heat dissipation members is mounted to one side of a stack of the battery cells, whereby heat generated from the battery cells during the charge and discharge of the battery cells is removed by the heat exchange member.

Furthermore, Japanese National Publication (JP-A) No. 2018-510463 discloses a battery module comprising: a module case including a lower plate and a sidewall forming an inside space; plural battery cells provided in the inside space of the module case; and a resin layer provided in the inside space of the module case, wherein the resin layer is in contact with the plurality of battery cells and also in contact with the lower plate or the sidewall of the module case.

Furthermore, International Publication (WO) No. 2012/081311 discloses a battery having a structure where a positive electrode member having a positive electrode active material and a current collector and a negative electrode member having a negative electrode active material and a current collector are layered so as to face each other with a separator member disposed therebetween and are housed together with an electrolyte in a casing and where a heat transfer plate is disposed so as to be joined to an outer surface of the casing, wherein the heat transfer plate includes a region in direct contact with the outer surface of the casing and a region having a joining material disposed to join the heat transfer plate to the outer surface of the casing.

### SUMMARY

Electrode bodies inside battery modules generate heat during charging and discharging and when a short-circuit occurs. Efficient dissipation of the heat generated by the electrode bodies to the outside is desired. From the standpoint of implementing this heat dissipation, the battery module disclosed in Japanese National Publication No. 2012-511802 has a configuration where the heat dissipation members are disposed between the plurality of battery cells each having the battery case formed of the laminate sheet, and the battery disclosed in International Publication No. 2012/081311 also has a configuration disposed with the heat transfer plate for heat dissipation. Further, the battery module disclosed in Japanese National Publication No. 2018-510463 has a configuration where the plurality of battery cells and the resin layer are provided in the inside space of the module case and where the resin layer is in contact with the plurality of battery cells and also in contact with the lower plate or the sidewall of the module case.

However, more efficient dissipation of the heat from the electrode body is desired.

The present disclosure has been devised in view of the above circumstances, and provides a battery module that can efficiently dissipate heat generated by an electrode body.

<1>A battery module, including:
a battery cell including an electrode body including plural layered structures layered one on another, each including a positive electrode, a negative electrode, and a separator disposed between the positive electrode and the negative electrode, and a battery cell case that hermetically encloses the electrode body inside the battery cell case; and
a heat dissipation member that is in contact with the battery cell case,
wherein the battery cell case includes at least a metal layer and a fusion resin layer disposed at the inner face side of the metal layer and includes, at at least part of the outer face of the battery cell case, an exposed portion at which the metal layer is exposed, and
the heat dissipation member is in contact with the exposed portion.

<2>The battery module of <1>, wherein an electrode face of the electrode body has a rectangular shape, and the exposed portion is disposed at an end portion on a long side of the rectangular shape.

<3>The battery module of <1>or <2>, wherein the battery cell case includes the exposed portion on the outer face of a region E at which the inner face of the battery cell case is in contact with the electrode body, and the heat dissipation member is in contact with the exposed portion in the region E.

<4>The battery module of any one of <1>to <3>, wherein the battery cell case includes a first sheet having the exposed portion and a second sheet not having the exposed portion, and the average thickness of the metal layer in the first sheet is greater than the average thickness of the metal layer in the second sheet.

<5>The battery module of any one of <1>to <4>, wherein the battery module includes, as the heat dissipation member, at least one of a battery module case or a condenser, and at least one of the battery module case or the condenser is in contact with the exposed portion.

<6>The battery module of any one of <1>to <4>, wherein the battery module includes at least one of a battery module case or a condenser and includes a resin member that contacts and connects the battery cell case and the at least one of the battery module case or the condenser, serving as the heat dissipation member, and the resin member is in contact with the exposed portion.

According to the present disclosure, there can be provided a battery module that can efficiently dissipate heat generated by an electrode body.

### BRIEF DESCRIPTION OF THE DRAWINGS

FIG. 1 is schematic cross-sectional view exemplifying a battery cell used in a battery module according to an embodiment of the present disclosure;

FIG. 2 is a schematic cross-sectional view exemplifying the battery module according to the embodiment of the present disclosure;

FIG. 3 is a schematic cross-sectional view exemplifying another aspect of the battery module according to the embodiment of the present disclosure;

FIG. 4 is a schematic cross-sectional view exemplifying another aspect of the battery module according to the embodiment of the present disclosure;

FIG. 5 is a schematic perspective view showing a cross-section and other faces seen from a perspective direction of a battery cell used in the battery module according to the embodiment of the present disclosure;

FIG. 6 is a schematic perspective view showing a cross-section and other faces seen from a perspective direction of a battery cell used in the battery module according to the embodiment of the present disclosure;

FIG. 7 is a schematic plan view showing main parts of a vehicle;

FIG. 8 is a schematic perspective view of a battery module;

FIG. 9 is a plan view of the battery module in a state in which a top cover is removed; and

FIG. 10 is a schematic view of the battery cell housed in the battery module as seen from its thickness direction.

### DETAILED DESCRIPTION

### <Battery Module>

A battery module according to an embodiment of the present disclosure includes a battery cell and a heat dissipation member. The battery cell includes an electrode body including plural layered structures layered one on another, each including a positive electrode, a negative electrode, and a separator disposed between the positive electrode and the negative electrode, and a battery cell case that hermetically encloses the electrode body inside the battery cell case. The heat dissipation member is disposed in contact with the battery cell case.

The battery cell case includes at least a metal layer and a fusion resin layer disposed at the inner face side of the metal layer. The battery cell case has an exposed portion at which the metal layer is exposed at at least part of the outer face of the battery cell case. It will be noted that a protective resin layer may be disposed on part of the outer face of the metal layer. Additionally, the heat dissipation member is in contact with the exposed portion.

An embodiment of the battery module according to the embodiment of the present disclosure will be described below using the drawings.

Each of the drawings described below is schematically rendered, and sizes and shapes of parts shown in the drawings are exaggerated as appropriate to facilitate understanding. Throughout the drawings, corresponding members are denoted by the same reference character, and overlapping descriptions thereof may be omitted, as appropriate.

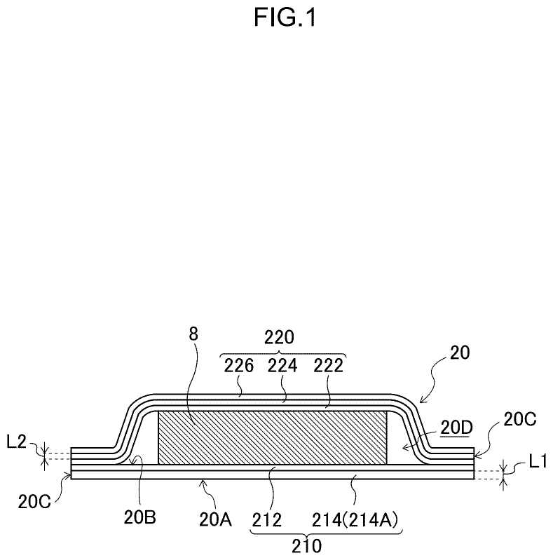

First, a battery cell used in the battery module according to the embodiment of the present disclosure will be described. FIG. 1 is a schematic cross-sectional view exemplifying a battery cell used in the battery module according to the embodiment of the present disclosure.

A battery cell 20 shown in FIG. 1 includes an electrode body 8 and a battery cell case that hermetically encloses the electrode body 8 inside the battery cell case and is configured by a first sheet 210 and a second sheet 220. The electrode body 8 includes plural layered structures layered one on another, each layered structure including a positive electrode, a negative electrode, and a separator disposed between the positive electrode and the negative electrode.

End portions of the first sheet 210 and the second sheet 220 configuring the battery cell case are fused together to form a housing portion 20D that hermetically encloses the electrode body 8 inside the housing portion 20D. The first sheet 210 of the battery cell case includes a metal layer 214 and a fusion resin layer 212 that is disposed at the inner face side of the metal layer 214. The second sheet 220 of the battery cell case includes a metal layer 224 and a fusion resin layer 222 that is disposed at the inner face side of the metal layer 224, and a protective resin layer 226 is further disposed on the outer face of the metal layer 224. The first sheet 210 has an exposed portion 214A at which the metal layer 214 is exposed, on the entire face of an outer face 20A of the first sheet 210. By contrast, on the outer face of the battery cell case 20, the metal layer 224 of the second sheet 220 is not exposed.

Here, “exposed portion” refers to a region on the outer face of the battery cell case at which a metal layer is exposed. Consequently, even if a metal layer is exposed on the inner face (e.g., an inner face 20B of the first sheet 210 in FIG. 1) and side faces (e.g., side faces 20C of the first sheet 210, which refers for example to cut end faces formed by fusing together the end portions of the first sheet 210 and the second sheet 220 and thereafter trimming the fused portions), those regions do not correspond to an exposed portion.

### First Battery Module

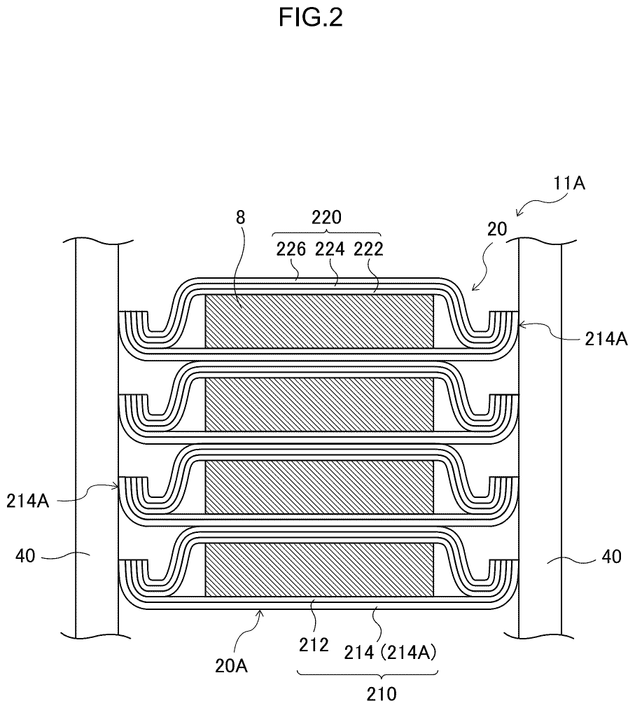

Next, the battery module according to the embodiment of the present disclosure will be described. FIG. 2 is a schematic cross-sectional view exemplifying a battery module according to the embodiment of the present disclosure.

A battery module 11A shown in FIG. 2 includes the battery cell 20 shown in FIG. 1. In the battery module 11A, plural battery cells 20 are layered, and in FIG. 2 four of the layered battery cells 20 are shown enlarged. It will be noted that additional battery cells are further layered on the upper side and on the lower side of the battery cells 20 shown in FIG. 2.

The battery module 11A includes a battery module case 40 that is an example of a heat dissipation member, and the layered battery cells 20 are housed inside the battery module case 40. The battery module case 40 is disposed in contact with the exposed portions 214A of the first sheets 210 of the battery cell cases. It will be noted that the fused portions at which the end portions of the first sheets 210 and the second sheets 220 are fused together are bent in curved shapes, and the exposed portions 214A at the distal end sides of the fused portions are disposed in plane contact with the battery module case 40.

The battery module according to the embodiment of the present disclosure can, by virtue of having the above configuration, efficiently dissipate heat generated by an electrode body.

An electrode body generates heat during charging and discharging and when a short- circuit occurs. To dissipate the heat generated by the electrode body to the outside, conventionally for example a battery cell case has been disposed in contact with a heat dissipation member provided outside the battery cell (e.g., a battery module case or a resin layer disposed between the battery module case and the battery cell case). Namely, a heat transfer path has been formed from the electrode body inside the battery cell through the battery cell case to the heat dissipation member. However, in conventional battery modules, sheets with a three-layer structure including a metal layer and resin layers disposed at both sides of the metal layer (specifically, a fusion resin layer disposed at the inner face side of the metal layer and a protective resin layer disposed at the outer face side of the metal layer) are commonly used as the battery cell case. For example, the battery cell is formed by using two of the sheets with the three-layer structure and fusing together the end portions of both sheets to hermetically enclose the electrode body inside. However, in a battery cell case having this configuration, the only places at which the metal layers are exposed are on the side faces (e.g., cut end faces formed by trimming the fused portions at which the end portions of the two sheets are fused together), and the exposed regions are limited to regions equal to the thickness of the metal layers. Consequently, the parts at which the battery cell case is in direct contact with the heat dissipation member provided outside the battery cell are the resin layers or the metal layers exposed at the side faces, and the area at which the metal layers and the heat dissipation member are in contact is only a small area at which they are in substantially linear contact. Here, when the battery cell case is used as a heat transfer path, it is the metal layers that should mainly contribute to heat transfer during heat dissipation. For that reason, conventionally, the portions at which the battery cell case and the heat dissipation member are in contact with each other become a rate determining process of the heat transfer path, and heat transfer has not been efficiently performed.

By contrast, the battery module according to the embodiment of the present disclosure has an exposed portion at which a metal layer is exposed on an outer face of a battery cell case, and the exposed portion is in contact with the heat dissipation member. Namely, the area at which the metal layer and the heat dissipation member are in direct contact is large, so the limitation imposed by the rate determining process of the heat transfer path can be alleviated, and heat transfer during heat dissipation is efficiently performed. As a result, the heat generated by an electrode body can be efficiently dissipated.

Furthermore, separate dedicated members for heat dissipation are not provided in the battery cell, and the battery cell case is employed as a heat transfer path, so this leads to a reduction in the number of parts and structural efficiency can also be enhanced.

It will be noted that although an aspect has been described in which the battery module 11A shown in FIG. 2 includes the battery module case 40 as a heat dissipation member and the exposed portion 214A is in contact with the battery module case 40, the battery module is not limited to this. An aspect in which the battery module includes a condenser (e.g., a cold plate including a refrigerant inside the cold plate) as a heat dissipation member and the exposed portion is in contact with the condenser may also be employed. Furthermore, an aspect in which the battery module includes both a battery module case and a condenser as heat dissipation members and the exposed portion is in contact with the battery module case and the condenser may also be employed.

Moreover, aspects in which the battery module includes at least one of a battery module case or a condenser and includes, as a heat dissipation member, a resin member that contacts and connects the battery cell case and the at least one of the battery module case or the condenser and in which the resin member and the exposed portion are in contact may also be employed.

Aspects in which the battery module includes a resin member as a heat dissipation member and in which the resin member and the exposed portion are in contact will be described below using the drawings.

### Second Battery Module

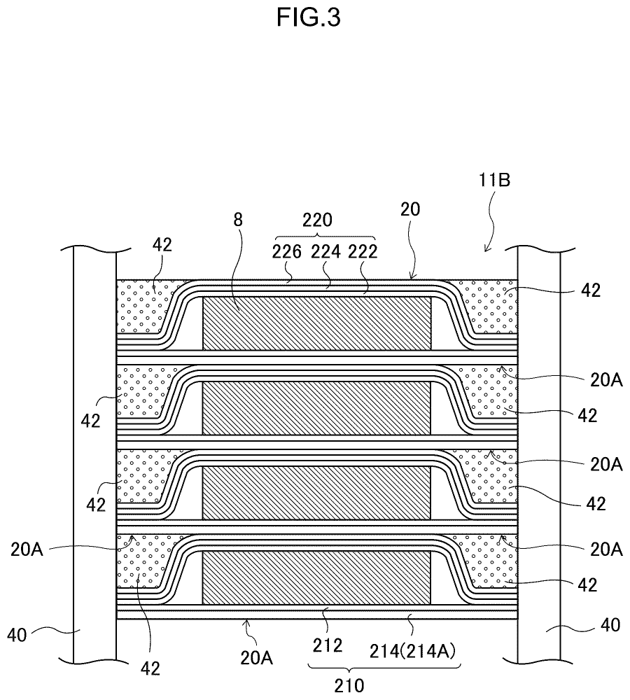

FIG. 3 is a schematic cross-sectional view exemplifying another example of the battery module according to the embodiment of the present disclosure.

A battery module 11B shown in FIG. 3 includes the battery cell 20 shown in FIG. 1. In the battery module 11B, plural battery cells 20 are layered, and in FIG. 3 four of the layered battery cells 20 are shown enlarged. It will be noted that additional battery cells are further layered on the upper side and on the lower side of the battery cells 20 shown in FIG. 3.

The battery module 11B includes a battery module case 40, and the layered battery cells 20 are housed inside the battery module case 40. Additionally, resin members 42 that are an example of heat dissipation members are disposed in voids between the battery module case 40 and the battery cells 20, and the voids are filled with the resin members 42 to secure the battery cells 20. The resin members 42 contact and connect the battery module case 40 and the battery cell cases and are disposed in such a way that the resin members 42 are in contact with the exposed portions 214A of the battery cell cases.

In this way, the battery module has the exposed portions, at which the metal layers are exposed, on the outer faces of the battery cell cases, the exposed portions are in contact with the resin members that are an example of heat dissipation members, and the resin members are in contact with the battery module case, whereby the limitation imposed by the rate determining process of the heat transfer path can be alleviated and heat transfer during heat dissipation is efficiently performed. As a result, the heat generated by the electrode bodies can be efficiently dissipated. Furthermore, separate dedicated members for heat dissipation are not provided in the battery cells, and the battery cell cases are employed for heat transfer paths, so this leads to a reduction in the number of parts and structural efficiency can also be enhanced.

### Third Battery Module

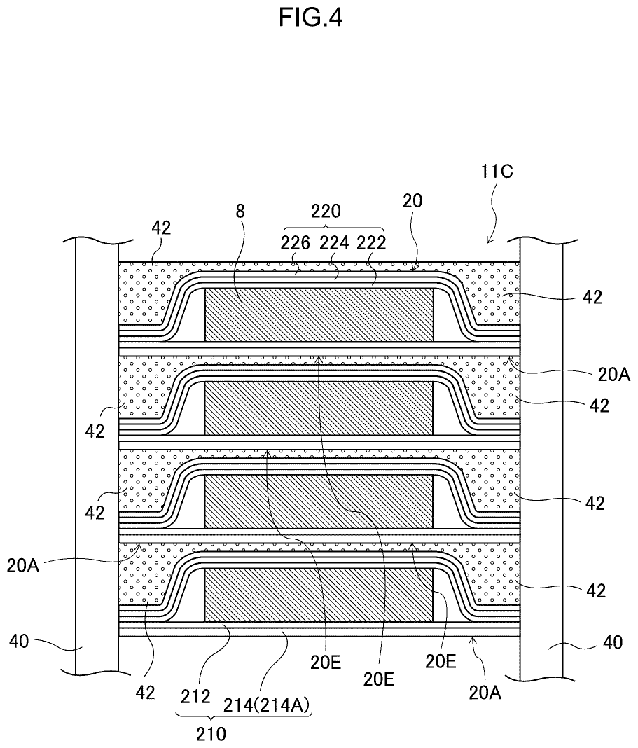

A battery module of yet another aspect will now be described. FIG. 4 is a schematic cross-sectional view exemplifying another example of the battery module according to the embodiment of the present disclosure.

A battery module 11C shown in FIG. 4 includes the battery cell 20 shown in FIG. 1. In the battery module 11C, plural battery cells 20 are layered, and in FIG. 4 four of the layered battery cells 20 are shown enlarged. It will be noted that additional battery cells are further layered on the upper side and on the lower side of the battery cells 20 shown in FIG. 4. Furthermore, in FIG. 4, the layered battery cells 20 are not in contact with each other, and intercellular voids are formed between the battery cells 20.

The battery module 11C includes a battery module case 40, and the layered battery cells 20 are housed inside the battery module case 40. Additionally, resin members 42 that are an example of heat dissipation members are disposed in voids between the battery module case 40 and the battery cells 20, and the voids are filled with the resin members 42 to secure the battery cells 20. Consequently, the intercellular voids formed by the battery cells 20 not being in contact with each other are also filled with the resin members 42.

The resin members 42 contact and connect the battery module case 40 and the battery cell cases and are disposed in such a way that the resin members 42 are in contact with the exposed portions 214A of the battery cell cases.

In this way, the battery module has the exposed portions, at which the metal layers are exposed, on the outer faces of the battery cell cases, the exposed portions are in contact with the resin members that are an example of heat dissipation members, and the resin members are in contact with the battery module case, whereby limitation imposed by the rate determining process of the heat transfer path can be alleviated and heat transfer during heat dissipation is efficiently performed. As a result, the heat generated by the electrode bodies can be efficiently dissipated. Furthermore, separate dedicated members for heat dissipation are not provided in the battery cells, and the battery cell cases are employed for heat transfer paths, so this leads to a reduction in the number of parts and structural efficiency can also be enhanced.

Moreover, the battery cell cases have the exposed portions 214A on the outer faces of regions 20E at which the inner faces of the battery cell cases are in contact with the electrode bodies 8, and the resin members 42 that are an example of heat dissipation members are in contact with the exposed portions 214A in the regions 20E. For that reason, the heat from the electrode bodies that are heat emitting sites can be more efficiently transferred, and heat dissipation is more efficiently performed.

It will be noted that from the standpoint of more efficiently performing heat dissipation, it is preferred that the entire surfaces of the exposed portions of the battery cell cases be covered by the resin members (that the resin members be in direct contact with them).

It will be noted that although aspects have been described in which, in the battery module 11B shown in FIG. 3 and the battery module 11C shown in FIG. 4, the resin members that are heat dissipation members are contacted with and connected to the battery module case 40, the battery module is not limited to this. An aspect in which the battery module includes a condenser (e.g., a cold plate including a refrigerant inside the cold plate) and the resin members are contacted with and connected to the condenser may also be employed. Furthermore, an aspect in which the battery module includes both a battery module case and a condenser and the resin members, serving as heat dissipation members, are contacted with and connected to the battery module case and the condenser may also be employed.

### (Resin Members)

Here, the resin members shown in FIG. 3 and FIG. 4 will be described.

The resin members, which are an example of heat dissipation members and contact and connect the battery cell cases and at least one of the battery module case or the condenser, need to be thermally conductive.

The thermal conductivity of the resin members is preferably 1.5 W/mk or higher for example. At the same time, the upper limit of thermal conductivity is not particularly limited, and the thermal conductivity can for example be at least 50 W/mk. The thermal conductivity of the resin members is measured by the ASTM D5470 standard or the ISO 22007-2 standard.

Known curable resins for example can be used as the resin in the resin members. Examples of curable resins include acrylic-based resins, epoxy-based resins, urethane-based resins, olefin-based resins, ethylene vinyl acetate (EVA)-based resins, and silicone-based resins.

Furthermore, from the standpoint of enhancing thermal conductivity, fillers may be added to the resin members. Examples of fillers include ceramic fillers such as alumina, aluminum nitride (AIN), boron nitride (BN), silicon nitride, ZnO, SiC, and BeO, and carbon fillers such as graphite.

### (Roughening Treatment and Carbon Coating Treatment)

At the place in the battery cell case at which the exposed portion and a heat dissipation member (particularly when the battery module includes, as the heat dissipation member, at least one of a battery module case or a condenser) are in contact with each other, the surface of at least one of the metal layer in the exposed portion or the heat dissipation member has preferably been subjected to at least one of a roughening treatment or a carbon coating treatment. Such a treatment enables more efficient heat dissipation. It will be noted that even when a carbon coating treatment is performed, the heat dissipation member and the exposed portion are regarded as being in direct contact (at the foregoing place).

Furthermore, when the heat dissipation member is a resin member, at the place at which the resin member that is the heat dissipation member and at least one of the battery module case or the condenser are in contact, it is preferable that the surface of the heat dissipation member or the surface of at least one of the battery module case or the condenser, or both, have been subjected to at least one of a roughening treatment or a carbon coating treatment.

### (Position of Exposed Portion)

Aspects have been described in which, in the battery module 11A shown in FIG. 2, the battery module 11B shown in FIG. 3, and the battery module 11C shown in FIG. 4, the exposed portion 214A at which the metal layer 214 is exposed is provided at the entire outer face of the first sheet 210 of the battery cell case. However, the exposed portion is not limited to this and may be formed on just part of the outer face.

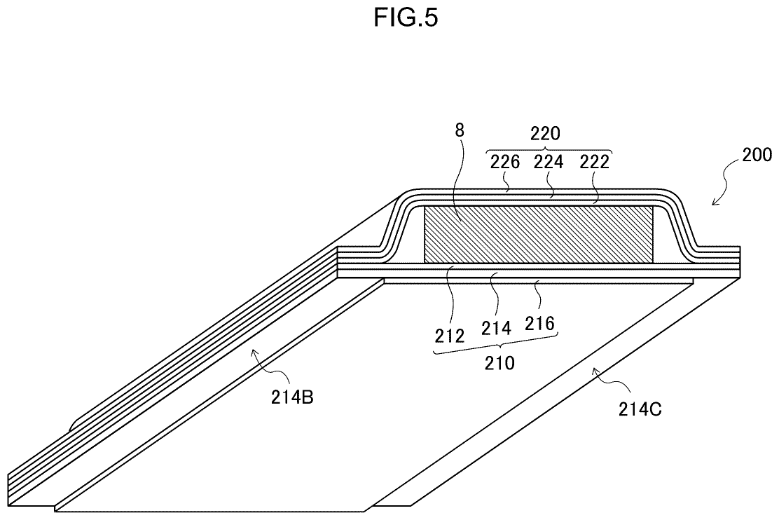

For example, as shown in a battery cell 200 of FIG. 5, an electrode face of the electrode body 8 may have a rectangular shape and the exposed portion may be disposed at end portions 214B and 214C along the long sides of the rectangular shape. Here, a protective resin layer 216 is provided as the outermost layer, in the region other than the end portions 214B and 214C. It will be noted that although FIG. 5 shows an aspect in which the exposed portion is formed on both end portions 214B and 214C along the long sides of the rectangular shape, the exposed portion may alternatively be formed on just one end portion along a long side.

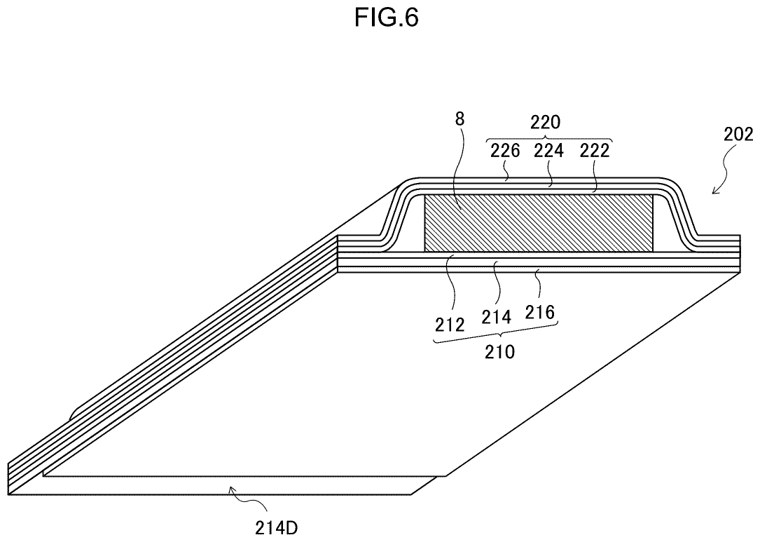

Furthermore, as shown in a battery cell 202 of FIG. 6, the electrode face of the electrode body 8 may have a rectangular shape and the exposed portion may be disposed at an end portion 214D along a short side of the rectangular shape. It will be noted that although FIG. 6 shows an aspect in which the exposed portion is formed at the one end portion 214D along a short side of the rectangular shape, the exposed portion may alternatively be formed at both end portions along the short sides (in which case another end portion would be provided at the near side relative to the cross-section of FIG. 6).

It will be noted that FIG. 5 and FIG. 6 are schematic perspective views showing cross- sections and other faces seen from perspective directions of battery cells for use in battery modules according to the embodiment of the present disclosure.

However, when the electrode face of the electrode body has a rectangular shape, the exposed portion is preferably disposed at least at an end portion along a long side of the rectangular shape (namely, the battery cell 200 shown in FIG. 5 is preferable to the battery cell 202 shown in FIG. 6). When the exposed portion is disposed at least at an end portion along a long side of the rectangular shape, compared to a case in which the exposed portion is disposed at an end portion along a short side, the distance between the center portion of the electrode body that has particularly high tendency toward heat accumulation and the exposed portion of the battery cell case can be reduced and the cross-sectional area of the heat transfer path during heat dissipation can be increased. Because of this, heat dissipation can be more efficiently performed.

### (Thickness of Metal Layers)

The thickness of the metal layer in the battery cell case is not particularly limited. When the battery cell case is configured by two or more sheets including a first sheet having the exposed portion (e.g., the first sheet 210 shown in FIG. 1) and a second sheet not having the exposed portion (e.g., the second sheet 220 shown in FIG. 1), the average thickness of the metal layer in the first sheet (e.g., an average thickness L1 of the metal layer 214 shown in FIG. 1) is preferably greater than the average thickness of the metal layer in the second sheet (e.g., an average thickness L2 of the metal layer 224 shown in FIG. 1). When the average thickness of the metal layer in the first sheet is greater than the average thickness of the metal layer in the second sheet, the cross-sectional area of the heat transfer path during heat dissipation can be increased and heat dissipation can be more efficiently performed.

It will be noted that “average thickness” means the arithmetic mean value of layer thicknesses at ten freely-selected places in the metal layers.

Next, a battery pack including the battery module according to the embodiment of the present disclosure, and a vehicle will be described using the drawings.

### (Overall Configuration of Vehicle 100)

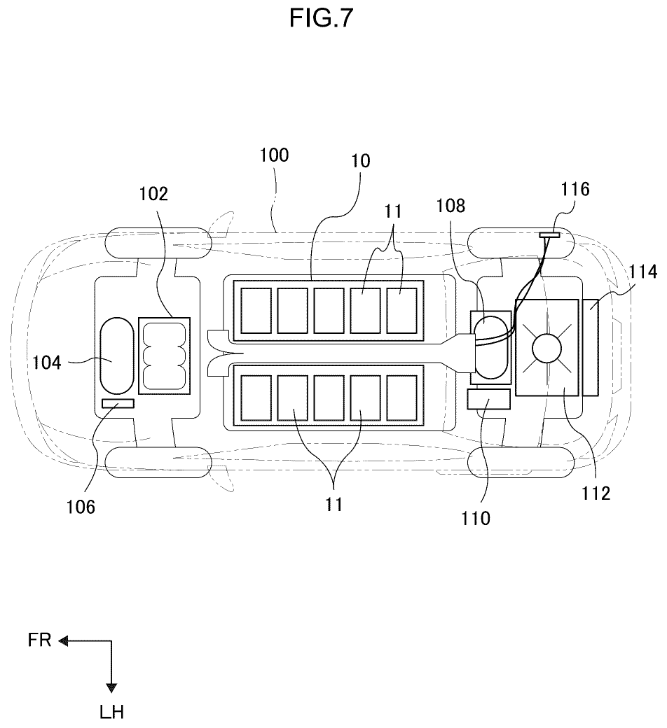

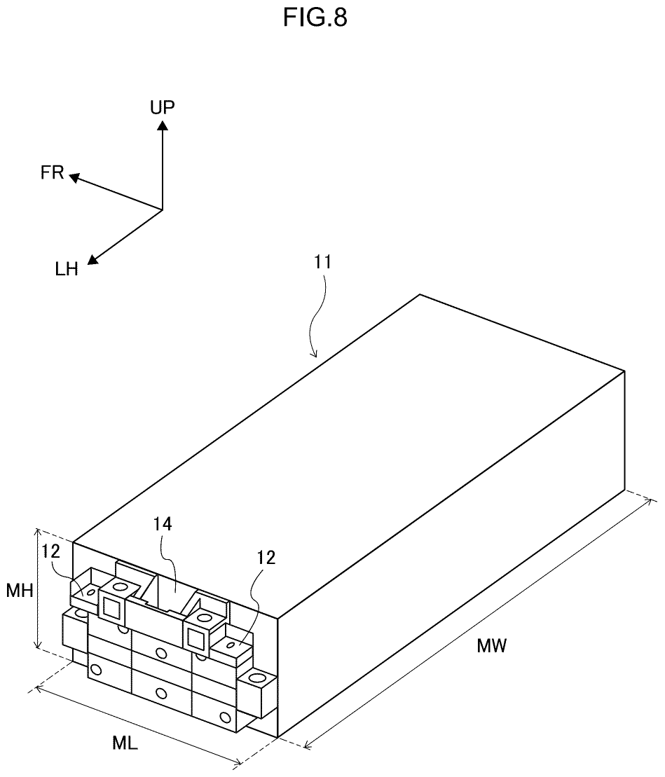

FIG. 7 is a schematic plan view showing main parts of a vehicle 100 to which a battery pack 10 according to the embodiment has been applied. As shown in FIG. 7, the vehicle 100 is a battery electric vehicle (BEV) in which the battery pack 10 is installed under the floor. It will be noted that in FIG. 7 and FIG. 8 arrow UP, arrow FR, and arrow LH indicate an upward direction in the vehicle up and down direction, a forward direction in the vehicle front and rear direction, and a leftward direction in the vehicle width direction, respectively. When description is given using the directions of front/rear, left/right, and upper/lower, unless otherwise specified these shall mean front/rear in the vehicle front and rear direction, left/right in the vehicle width direction, and upper/lower in the vehicle up and down direction.

In the vehicle 100 of the present embodiment, as an example, a DC/DC converter 102, an electric compressor 104, and a positive temperature coefficient (PTC) heater 106 are disposed on the vehicle front side of the battery pack 10. Furthermore, a motor 108, a gearbox 110, an inverter 112, and a charger 114 are disposed on the vehicle rear side of the battery pack 10.

Direct current output from the battery pack 10 has its voltage regulated by the DC/DC converter 102 and is thereafter supplied to the electric compressor 104, the PTC heater 106, the inverter 112, and elsewhere. Furthermore, power is supplied via the inverter 112 to the motor 108, whereby rear wheels rotate and cause the vehicle 100 to travel.

A charging port 116 is provided in the right side portion of the rear portion of the vehicle 100. By connecting a charging plug of an outside charging station (not shown in the drawings) to the charging port 116, power can be stored in the battery pack 10 via the on- board charger 114.

It will be noted that the arrangement and structures of the parts configuring the vehicle 100 are not limited to the configurations described above. For example, the battery module according to the embodiment may also be applied to a hybrid vehicle (HV) or a plug-in hybrid electric vehicle (PHEV) in which an engine is installed. Furthermore, in the present embodiment, the vehicle is described as a rear-wheel-drive vehicle in which the motor 108 is installed in the rear portion of the vehicle, but the vehicle is not limited to this and may be a front-wheel-drive vehicle in which the motor 108 is installed in the front portion of the vehicle or a vehicle in which a pair of the motors 108 are installed in the front and rear of the vehicle. Moreover, the vehicle may be a vehicle in which each wheel has an in-wheel motor.

Here, the battery pack 10 includes plural battery modules 11. In the present embodiment, as an example, the battery pack 10 is provided with ten battery modules 11. Specifically, five battery modules 11 are arrayed in the vehicle front and rear direction on the right side of the vehicle 100, and five battery modules 11 are arrayed in the vehicle front and rear direction on the left side of the vehicle 100. Furthermore, the battery modules 11 are electrically interconnected.

FIG. 8 is a schematic perspective view of the battery module 11. As shown in FIG. 8, the battery module 11 is formed substantially in the shape of a rectangular cuboid of which lengthwise direction coincides with the vehicle width direction. Furthermore, a shell of the battery module 11 is formed of an aluminum alloy. For example, the shell of the battery module 11 is formed by joining, by means of laser welding or the like, aluminum die cast products to both end portions of an extruded material of aluminum alloy.

Both vehicle width direction end portions of the battery module 11 are provided with a pair of voltage terminals 12 and a connector 14. A flexible printed circuit 22 described later is connected to the connector 14. Furthermore, busbars (not shown in the drawings) are welded to both vehicle width direction end portions of the battery module 11.

The battery module 11 has a vehicle width direction length MW that is, for example, 350 mm to 600 mm, a vehicle front and rear direction length ML that is, for example, 150 mm to 250 mm, and a vehicle up and down direction height MH that is, for example, 80 mm to 110 mm.

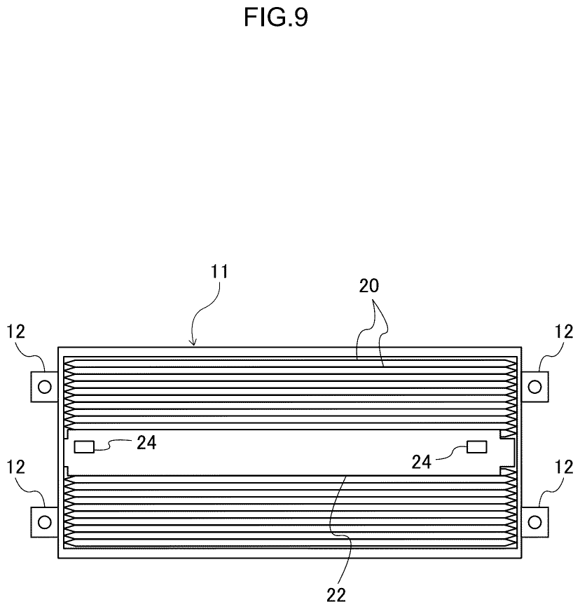

FIG. 9 is a plan view of the battery module 11 in a state in which a top cover is removed. As shown in FIG. 9, inside the battery module 11 plural battery cells 20 are housed in an arrayed state. In the present embodiment, as an example, twenty-four battery cells 20 are arrayed in the front and rear direction and adhered to each other.

On the battery cells 20 is disposed a flexible printed circuit (FPC) 22. The flexible printed circuit 22 is formed in the shape of a band of which lengthwise direction coincides with the vehicle width direction, and thermistors 24 are provided on both end portions of the flexible printed circuit 22. The thermistors 24 are not adhered to the battery cells 20 but are configured to be pressed toward the battery cells 20 by the top cover of the battery module 11.

Furthermore, inside the battery module 11 one or plural cushioning members (not shown in the drawings) are housed. For example, the cushioning members are clastically deformable laminar members and are disposed between adjacent battery cells 20 in such a way that their thickness direction coincides with the array direction of the battery cells 20. In the present embodiment, as an example, the cushioning members are disposed at both lengthwise direction end portions and the lengthwise direction central portion of the battery module 11.

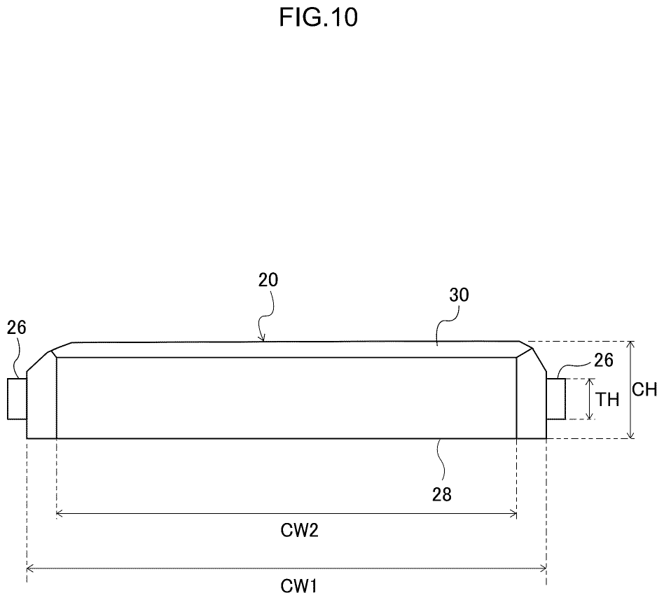

FIG. 10 is a schematic view of the battery cell 20 housed in the battery module 11 as seen from its thickness direction. As shown in FIG. 10, the battery cell 20 is formed substantially in the shape of a rectangular plate, and an electrode body (not shown in the drawings) is housed inside the battery cell 20. The electrode body is configured by layering positive electrodes, negative electrodes, and separators and is hermetically enclosed by a laminate film 28.

In the present embodiment, as an example, a housing portion of the electrode body is formed by folding over and bonding the laminate film 28 that is sheet-shaped and embossed. It will be noted that although a single cup embossed structure that is embossed in one place and a double cup embossed structure that is embossed in two places can be employed, in the present embodiment a single cup embossed structure with a draw depth of about 8 mm to 10 mm is employed.

The upper ends of both lengthwise direction end portions of the battery cell 20 are bent, and the corners form parts of the outline of the battery cell 20. Furthermore, the upper end portion of the battery cell 20 is bent, and a fixing tape 30 is wrapped along the lengthwise direction around the upper end portion of the battery cell 20.

Here, both lengthwise direction end portions of the battery cell 20 are each provided with a terminal (tab) 26. In the present embodiment, as an example, the terminals 26 are provided in positions downwardly offset from the up and down direction center of the battery cell 20. The terminals 26 are joined by laser welding or the like to busbars (not shown in the drawings).

A vehicle width direction length CW1 of the battery cell 20 is, for example, 530 mm to 600 mm, a length CW2 of the region at which the electrode body is housed is, for example, 500 mm to 520 mm, and a height CH of the battery cell 20 is, for example, 80 mm to 110 mm. Furthermore, the thickness of the battery cell 20 is, for example, 7.0 mm to 9.0 mm, and a height TH of the terminals 26 is, for example, 40 mm to 50 mm.

The respective reference characters in the drawings designate the following elements.
20A: Outer Face
20B: Inner Face
20C: Side Face
210: First Sheet
220: Second Sheet
212, 222: Fusion Resin Layer
214, 224: Metal Layer
214A, 214B, 214C, 214D: Exposed Portion
216, 226: Protective Resin Layer
40: Battery Module Case
42: Resin Member
8: Electrode Body
10: Battery Pack
11, 11A, 11B, 11C: Battery Module
12: Voltage Terminal
14: Connector
20: Battery Cell
22: Flexible Print Circuit
24: Thermistor
26: Terminal
28: Laminate Film
30: Fixing Tapc
100: Vehicle
102: Converter
104: Electric Compressor
106: Heater
108: Motor
110: Gear Box
112: Inverter
114: On-board Charger
116: Charging Port

What is claimed is:

1. A battery module, comprising:
a battery cell including an electrode body including a plurality of layered structures layered one on another, each including a positive electrode, a negative electrode, and a separator disposed between the positive electrode and the negative electrode, and a battery cell case that hermetically encloses the electrode body inside the battery cell case; and
a heat dissipation member that is in contact with the battery cell case,
wherein the battery cell case includes at least a metal layer and a fusion resin layer disposed on an inner face side of the metal layer and includes, at at least part of an outer face of the battery cell case, an exposed portion at which the metal layer is exposed, and
the heat dissipation member is in contact with the exposed portion.

2. The battery module of claim 1, wherein an electrode face of the electrode body has a rectangular shape, and the exposed portion is disposed at an end portion on a long side of the rectangular shape.

3. The battery module of claim 1, wherein the battery cell case has the exposed portion on an outer face of a region E at which an inner face of the battery cell case is in contact with the electrode body, and the heat dissipation member is in contact with the exposed portion in the region E.

4. The battery module of claim 1, wherein the battery cell case includes a first sheet having the exposed portion and a second sheet not having the exposed portion, and an average thickness of the metal layer in the first sheet is greater than an average thickness of the metal layer in the second sheet.

5. The battery module of claim 1, wherein the battery module includes, as the heat dissipation member, at least one of a battery module case or a condenser, and the at least one of the battery module case or the condenser is in contact with the exposed portion.

6. The battery module of claim 1, wherein the battery module includes at least one of a battery module case or a condenser and includes a resin member that contacts and connects the battery cell case and at least one of the battery module case or the condenser, serving as the heat dissipation member, and the resin member is in contact with the exposed portion.
